(19) United States
(12) Patent Application Publication
(10) Pub. No.: US 2007/0165661 A1
(43) Pub. Date: Jul. 19, 2007

(54) Information-processing system, reception device, and program

(75) Inventor: Hiroshi Kyusojin, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Sony Corporation

(21) Appl. No.: 11/636,573

(22) Filed: Dec. 11, 2006

(30) Foreign Application Priority Data
Dec. 19, 2005 (JP) P2005-364268

(51) Int. Cl. H04L 12/56

(52) U.S. Cl. 370/412

(57) ABSTRACT

An information-processing system includes a reception device configured to receive data and a data-processing device configured to perform data processing by using the data. The reception device includes a reception unit configured to receive the data, and a storage-control unit configured to generate format data which is data generated in a format ready for the data processing on the basis of the received data and store the format data and the data in a storage unit. The data-processing device includes a processing unit configured to perform the data processing by using the data and the format data that are stored in the storage unit.

### CROSS REFERENCES TO RELATED APPLICATIONS

The present invention contains subject matter related to Japanese Patent Application JP 2005-364268 filed in the Japanese Patent Office on Dec. 19, 2005, the entire contents of which are incorporated herein by reference.

### BACKGROUND OF THE INVENTION

1. Field of the Invention

The present invention relates to an information-processing system, a reception device, and a program, and particularly relates to an information-processing system, a reception device, and a program that allow for increasing the processing speed of a data-processing device configured to perform processing by using data received by the reception device.

2. Description of the Related Art

FIG. 1 is a block diagram of an example personal computer (hereinafter referred to as a PC) 1 including a network card 19 performing direct-memory-access (DMA) transfer by using a descriptor 50 (shown in FIG. 2 which will be described later).

As shown in FIG. 1, a central processing unit (CPU) 10 is connected to a read-only memory (ROM) 11, a random-access memory (RAM) 12, and a memory controller 13 via a bus 14. The CPU 10 performs various processing procedures according to a program such as a device driver stored in the ROM 11 and/or a record unit 18. Here, the unit (word) of processing performed by the CPU 10 is determined to be 32 bits.

For example, the CPU 10 stores information about the address of a packet area 32 provided, so as to record a packet which is DMA-transferred from the network card 19 via the memory controller 13, onto a descriptor area 31 of the RAM 12, as a descriptor 50. Further, the CPU 10 processes the packet which is DMA-transferred from the network card 19 to the packet area 32 of the RAM 12 on the basis of the descriptor 50 according to the program stored in the ROM 11 and/or the record unit 18.

Further, the CPU 10 starts an interruption handler of the device driver, so as to perform interruption processing by using the packet and the descriptor 50 corresponding to the packet.

The RAM 12 includes a descriptor area 31 onto which the descriptor 50 is recorded, the packet area 32 onto which the packet which is DMA-transferred from the network card 19 is recorded, and so forth. The memory controller 13 controls the RAM 12 and performs the DMA transfer between the RAM 12 and the network card 19. Further, the memory controller 13 stores reception information transmitted from the network card 19 in the descriptor 50 so that the descriptor 50 is updated, where the reception information is information about a packet transmitted from a different device.

An input-and-output interface 15 is connected to the CPU 10 via the bus 14. An input unit 16 including a keyboard, a mouse, and so forth, and an output unit 17 including a liquid-crystal display (LCD), a cathode-ray tube (CRT) display, and so forth are connected to the input-and-output interface 15. The CPU 10 performs various processing procedures according to an instruction input from the input unit 16. Further, the CPU 10 outputs data on an image and/or sound obtained through the processing procedures to the output unit 17.

The record-unit 18 connected to the input-and-output interface 15 includes a hard disk, for example, so as to record programs executed by the CPU 10 and/or various data items. The network card 19 receives a packet transmitted from a different device via a network (not shown), the packet being compliant with “Ethernet (Registered Trademark)” or the like, and DMA-transfers the packet to the RAM 12 via the memory controller 13. Further, the network card 19 generates reception information and transmits the reception information to the memory controller 13.

In the following description, the packet compliant with “Ethernet (Registered Trademark)” is transmitted from the different device, and the packet includes data to which an Ethernet header, an Internet Protocol Version 4 (IPv4) header, a Transmission Control Protocol (TCP) header, and so forth are added. Further, a Media-Access-Control (MAC) address is given to the network card 19.

When removable media 21 including a magnetic disk, an optical disk, a magneto-optical disk, a semiconductor memory, and so forth are inserted in a drive 20 connected to the input-and-output interface 15, the drive 20 drives the removable media 21 and acquires programs and/or data recorded onto the removable media 21. The acquired programs and/or data are transferred to the record unit 18 and recorded, as required.

FIG. 2 shows an example of the descriptor 50 recorded onto the descriptor area 31 shown in FIG. 1.

The descriptor 50 shown in FIG. 2 stores an address 51, a packet size 52, and a status 53.

The address 51 is a 32-bit address of the packet area 32 prepared to record a packet which is DMA-transferred from the network card 19. The packet size 52 denotes the size of the prepared packet area 32, or the data size of the packet actually recorded onto the packet area 32. The status 53 is information about details on an error which occurs when the packet recorded onto the packet area 32 at the address 51 is transmitted to the network card 19 (hereinafter referred to as error information). If the error does not occur, the error information indicating that no error occurs is stored in the descriptor 50, as the status 53.

Next, DMA-transfer processing performed by the PC 1 shown in FIG. 1 will be described with reference to FIG. 3.

At step S11, the CPU 10 executes the device driver stored in the ROM 11 and/or the record unit 18 so that the descriptor 50 shown in FIG. 2 is set (stored) to the descriptor area 31 of the RAM 12. At that time, information about an address of the packet area 32 prepared to record the packet which is DMA-transferred from the network card 19 is stored in the descriptor 50, as the address 51, and information about the size of the packet area 32 is stored in the descriptor 50, as the packet size 52.

After step S11, the processing advances to step S12 so that the CPU 10 executes the device driver, whereby a notice is transmitted to the network card 19, the notice indicating that the setting of the descriptor 50 is finished.

At step S21, the network card 19 receives the notice indicating that the setting of the descriptor 50 is finished, the notice being transmitted from the CPU 10, and advances to step S22. At step S22, the network card 19 requests the memory controller 13 to DMA-transfer the descriptor 50. Here, information about the address of the descriptor 31 and the size of the descriptor 50 is stored in the network card 19 in advance. The address-and-size information and the request for the DMA transfer of the descriptor 50 are transmitted to the memory controller 13.

At step S31, the memory controller 13 receives the address-and-size information and the request for the DMA transfer of the descriptor 50 that are transmitted from the network card 19 and advances to step S32. At step S32, the memory controller 13 reads the descriptor 50 from the descriptor area 31 of the RAM 12 on the basis of the address-and-size information transmitted from the network card 19 and advances to step S33.

At step S33, the memory controller 13 transmits the descriptor 50 read, at step S32, to the network card 19 so that the descriptor 50 is DMA-transferred.

At step S23, the network card 19 receives the descriptor 50 which is DMA-transferred from the memory controller 13, stores the descriptor 50 in an internal memory (not shown), and advances to step S24. At step S24, the network card 19 determines whether or not a packet is transmitted from a different device (not shown) via a network. If it is determined that the packet is not transmitted, the network card 19 waits until the packet is transmitted.

If it is determined that the packet is transmitted, at step S24, the network card 19 advances to step S25, specifies the address 51 of the stored descriptor 50, and transmits the transmitted packet to the memory controller 13, so that the packet is DMA-transferred.

At step S34, the memory controller 13 specifies the address 51, receives the packet which is DMA-transferred from the network card 19, and advances to step S35. At step S35, the memory controller 13 records the packet transmitted from the memory controller 13 onto the packet area 32 at the address 51.

At step S26, the network card 19 transmits information about the data size and error information of the packet transmitted, at step S24, to the memory controller 13, as reception information which is information about the transmitted packet, so that the reception information is DMA-transferred.

At step S36, the memory controller 13 receives the reception information which is DMA-transferred from the network card 19 and advances to step S37. At step S37, the memory controller 13 updates the descriptor 50 by storing the received reception information in the descriptor 50. More specifically, the memory controller 13 stores (updates) the data-size information of the reception information, as the packet size 52 of the descriptor 50 and stores the error information, as the status 53.

After step S37, the memory controller 13 advances to step S38 and transmits a notice to the network card 19, the notice indicating that the DMA transfer of the packet is finished, and finishes the processing.

At step S27, the network card 19 receives the notice transmitted from the memory controller 13, the notice indicating that the DMA transfer of the packet is finished, and advances to step S28. At step S28, the network card 19 transmits a notice about an interruption to the CPU 10 and finishes the processing.

At step S13, the CPU 10 receives the interruption notice transmitted from the network card 19 and advances to step S14. At step S14, the CPU 10 starts the interruption handler of the device driver and finishes the processing.

Next, the interruption processing performed by the interruption handler will be described with reference to FIG. 4. The interruption processing is started, for example, when the interruption handler is started, at step S14 shown in FIG. 3.

At step S51, the interruption handler reads the address 51 and the status 53 from the descriptor 50 recorded onto the descriptor area 31 of the RAM 12 and advances to step S52.

At step S52, the interruption handler determines whether or not the status 53 read, at step S51, indicates that an error occurs. If the interruption handler determines that the status 53 does not indicate the error occurrence, that is to say, the status 53 indicates that no error occurs, the interruption handler advances to step S53.

At step S53, the interruption handler reads the packet recorded onto the packet area 32 at the address 51 on the basis of the address 51 read, at step S51, and performs header processing, so as to remove the Ethernet header or the like from the read packet. After step S53, the interruption handler advances to step S54 so that the interruption handler hands over the packet that had been subjected to the header processing to a high-order Internet Protocol (IP) layer and advances to step S56.

On the other hand, if it is determined that the status 53 indicates the error occurrence, at step S52, the interruption handler abandons (deletes) the packet recorded onto the packet area 32 at the address 51 on the basis of the address 51 which is read, at step S51, and advances to step S56. At step S56, the interruption handler clears the interruption notice transmitted, at step S13 shown in FIG. 3, and finishes the processing.

In recent years, the use of a TCP/IP Offload Engine (TOE) or the like allows for performing predetermined processing by using a network card. In the past, the predetermined processing was performed by a CPU after the DMA transfer of the packet was finished. In that case, information about a result of the predetermined processing is stored in a descriptor.

In the past, for example, the CPU calculates a header check sum on the basis of a packet after the packet is DMA-transferred. When performing the calculation processing by using the network card 19, the header check sum obtained, as a result of the calculation processing, is stored in a descriptor 70, as shown in FIG. 5.

That is to say, the descriptor 70 shown in FIG. 5 stores the address 51, the packet size 52, the status 53, a header check sum 71, and a reserve 72. In FIG. 5, the same elements as those shown in FIG. 2 will not be described. The same elements shown in FIG. 5 are designated by the same reference numerals and/or characters as those shown in FIG. 2.

The header check sum 71 is a header check sum obtained through a calculation performed by the network card 19 on the basis of the packet. The reserve 72 is provided, as a free area.

When the descriptor 70 shown in FIG. 5 is recorded onto the descriptor area 31, the network card 19 calculates the header check sum on the basis of a transmitted packet and transmits information about the data size of the packet, error information of the packet, and information about the header check sum to the memory controller 13, as the reception information, at step S26 shown in FIG. 3.

In that case, the interruption processing performed by the interruption handler started, at step S14 shown in FIG. 3, will be described with reference to FIG. 6.

At step S71, the interruption handler reads the address 51, the status 53, and the header check sum 71 from the descriptor 70 (shown in FIG. 5) recorded onto the descriptor area 31 of the RAM 12, and advances to step S72.

At step S72, the interruption handler determines whether or not the status 53 indicates that an error occurs, as is the case with step S52 shown in FIG. 4. If it is determined that the status 53 does not indicate the error occurrence, the interruption handler advances to step S73.

At step S73, the interruption handler reads a packet recorded onto the packet area 32 at the address 51 on the basis of the address 51 read, at step S71, and determines whether or not a header check sum included in an IPv4 header of the read packet agrees with the header check sum 71 read, at step S71.

If it is determined that the header check sum included in the IPv4 header agrees with the header check sum 71, at step S73, the processing advances to step S74.

On the other hand, if it is determined that the status 53 indicates the error occurrence, at step S72, or if it is determined that the header check sum included in the IPv4 header does not agree with the header check sum 71, at step S73, the processing advances to step S76.

Since the processing corresponding to steps S74, S75, S76, and S77 is the same as the processing corresponding to steps S53, S54, S55, and S56 that are shown in FIG. 4. Therefore, the processing corresponding to steps S74 to S77 will not be described.

On the other hand, for example, an interruption handler operating on Linux analyzes a MAC address written in the Ethernet header of a transmitted packet and sets a value indicating the analysis result, as a packet type (skb->pkt_type), which is expressed by the function eth_type_trans.

The details on the packet type will be described with reference to FIG. 7.

When the value of the packet type is zero, as shown in FIG. 7, the packet type shows the analysis result indicating that the transmitted packet is a packet transmitted to an own device through unicast (PACKET_HOST). When the value of the packet type is one, the packet type shows the analysis result indicating that the transmitted packet is a packet transmitted through broadcast (PACKET_BROADCAST).

When the value of the packet type is two, the packet type shows the analysis result indicating that the transmitted packet is a packet transmitted through multicast (PACKET_MULTICAST). When the value of the packet type is three, the packet type shows the analysis result indicating that the transmitted packet is a packet transmitted to a different computer through unicast (PACKET_OTHERHOST).

Next, interruption processing performed by the interruption handler analyzing the MAC address will be described with reference to FIG. 8.

The interruption processing shown in FIG. 8 is the same as that shown in FIG. 4 except for the processing corresponding to step S93. That is to say, the processing corresponding to steps S91, S92, S94, S95, S96, and S97 is the same as that corresponding to steps S51, S52, S53, S54, S55, and S56. Therefore, the processing corresponding to steps S91, S92, and S94 to S97 will not be described, so as to avoid a repetition of the description.

At step S93, the interruption handler reads the packet recorded onto the packet area 32 at the address 51 on the basis of the address 51 of the descriptor 50 and performs setting processing, so as to set the packet type on the basis of the MAC address written in the Ethernet header of the read packet. The details on the setting processing will be described later with reference to FIG. 9.

Next, the setting processing corresponding to step S93 shown in FIG. 8 will be described with reference to FIG. 9.

At step S111, the interruption handler determines whether or not the least significant bit of the MAC address written in the Ethernet header of the packet read from the packet area 32 is one. That is to say, the interruption handler determines whether the read packet is a packet transmitted through broadcast or a packet transmitted through multicast.

At step S111, if it is determined that the least significant bit of the MAC address is not one, that is to say, if the read packet is the packet transmitted through unicast, the processing advances to step S112 so that the interruption handler determines whether or not the MAC address is the own device's address (a MAC address given to the network card 19).

At step S112, if it is determined that the MAC address is not the own device's address, that is to say, if the read packet is the packet transmitted to the different computer through unicast, the processing advances to step S113 so that the interruption handler sets the value of the packet type to three and advances to step S94 shown in FIG. 8.

On the other hand, if it is determined that the MAC address is the own device's address, that is to say, if the read packet is the packet transmitted to the own device through unicast, at step S112, the processing advances to step S114 so that the interruption handler sets the value of the packet type to zero and advances to step S94 shown in FIG. 8.

Further, if it is determined that the least significant bit of the MAC address is one, at step S111, the processing advances to step S115 so that the interruption handler determines whether or not the MAC address is a broadcast address, that is to say, whether or not every bit of the MAC address is one.

If it is determined that the MAC address is not the broadcast address, at step S115, the processing advances to step S116 so that the interruption handler sets the value of the packet type to two and advances to step S94 shown in FIG. 8.

On the other hand, if it is determined that the MAC address is the broadcast address, at step S115, the processing advances to step S117 so that the interruption handler sets the value of the packet type to one and advances to step S94 shown in FIG. 8.

Further, when the network card 19 analyzes the MAC address by using the TOE or the like, an address class showing the analysis result is stored in a descriptor 90, as shown in FIG. 10.

The descriptor 90 shown in FIG. 10 stores the address 51, the packet size 52, the status 53, an address class 91, and a reserve 92. In FIG. 10, the same elements as those shown in FIG. 2 will not be described. The same elements shown in FIG. 10 are designated by the same reference numerals and/or characters as those shown in FIG. 2.

The address class 91 denotes a value indicating the result of an analysis of the MAC address, the analysis being made by the network card 19. The reserve 92 is provided, as a free area.

Next, the address class 91 shown in FIG. 10 will be described with reference to FIG. 11.

When the value of the address class 91 is 0×20, as shown in FIG. 11, the address class 91 shows the analysis result indicating that a transmitted packet is a packet transmitted through multicast (RX_FLAG_MCAST). When the value of the address class 91 is 0×40, the address class 91 shows the analysis result indicating that the transmitted packet is a packet transmitted through broadcast (RX_FLAG_BCAST). Further, when the value of the address class 91 is 0×80, the address class 91 shows the analysis result indicating that the transmitted packet is a packet transmitted in promiscuous mode (RX_FLAG_MISS).

Here, the promiscuous mode denotes mode in which every packet is received. Any packet transmitted to a different computer through unicast is received in the promiscuous mode. Namely, the packet received in the promiscuous mode is a packet transmitted to the different computer through unicast.

Next, the setting processing corresponding to step S93 shown in FIG. 8 will be described with reference to FIG. 12, where the setting processing is performed when the network card 19 analyzes the MAC address.

At step S131, the interruption handler reads the address class 91 of the descriptor 90 recorded onto the descriptor area 31 and determines whether or not the value of the read address class 91 is 0×40, that is to say, whether or not the packet (a packet recorded onto the packet area 32 at the address 51 stored in the descriptor 90) corresponding to the descriptor 90 is a packet transmitted through broadcast.

If it is determined that the value of the address class 91 is 0×40, at step S131, the processing advances to step S132 so that the interruption handler sets the value of the packet type to one and advances to step S94 shown in FIG. 8.

On the other hand, if it is determined that the value of the address class is not 0×40, at step S131, the processing advances to step S133 so that the interruption handler determines whether or not the value of the address class 91 is 0×20, that is to say, whether or not the packet corresponding to the descriptor 90 is a packet transmitted through multicast.

If it is determined that the value of the address class 91 is 0×20, at step S133, the processing advances to step S134 so that the interruption handler sets the value of the packet type to two and advances to step S94 shown in FIG. 8.

Further, if it is determined that the value of the address class 91 is not 0×20, at step S133, the processing advances to step S135 so that the interruption handler determines whether or not the value of the address class 91 is 0×80, that is to say, whether or not the packet corresponding to the descriptor 90 is a packet received in the promiscuous mode.

If it is determined that the address class 91 is not 0×80, at step S135, the processing advances to step S136 so that the interruption handler sets the value of the packet type to zero and advances to step S94 shown in FIG. 8.

On the other hand, if it is determined that the value of the address class 91 is 0×80, at step S135, that is to say, if the packet corresponding to the descriptor 90 is a packet transmitted to the different computer through unicast, the processing advances to step S137 so that the interruption handler sets the value of the packet type to three and advances to step S94 shown in FIG. 8.

In the past, various methods of performing DMA-transfer processing with efficiency had been proposed, the various methods being performed by a device configured to perform the DMA-transfer processing. For example, there had been proposed a data-transfer-control device configured to DMA-transfer data without interruption at the turn of data segments by using two buffers alternately. The above-described technology is disclosed in Japanese Unexamined Patent Application Publication No. 2000-172634, for example. Further, there had been proposed a data-transfer device configured to transfer data with the maximum bus length even though the alignment disagreement occurs, as disclosed in Japanese Unexamined Patent Application Publication No. 2003-67321, for example.

### SUMMARY OF THE INVENTION

However, there has been proposed no idea about generating reception information in a format ready for processing such as interruption processing performed by using a packet which is DMA-transferred from a network card and increasing the speed of the processing so that a CPU can perform the processing with efficiency.

Accordingly, the present invention allows a data-processing device to perform processing with an increased speed, the data-processing device being configured to perform processing by using data received by a reception device.

According to a first embodiment of the present invention, there is provided an information-processing system including a reception device configured to receive data and a data-processing device configured to perform data processing by using the data. The reception device includes a reception unit configured to receive the data, and a storage-control unit configured to generate format data which is data generated in a format ready for the data processing on the basis of the received data and store the format data and the data in a storage unit. The data-processing device includes a processing-unit configured to perform the data processing by using the data and the format data that are stored in the storage unit.

According to a second embodiment of the present invention, there is provided a reception device making a storage unit store data used by a data-processing device, so as to perform data processing. The reception device includes a reception unit configured to receive the data, and a storage-control unit configured to generate format data which is data generated in a format ready for the data processing on the basis of the received data and store the format data and the data in the storage unit.

The format ready for the data processing is a size of a processing unit used when the data processing is performed.

The format ready for the data processing is a format in which a value used for the data processing is used.

According to a third embodiment of the present invention, there is provided a program making a computer perform processing so that a storage unit stores data used by a data-processing device, so as to perform data processing. The program includes the steps of receiving the data, and generating format data which is data generated in a format ready for the data processing on the basis of the received data and storing the format data and the data in the storage means.

According to the first embodiment, the data is received, the format data which is the data generated in the format adaptable for the data processing performed by using the data is generated on the basis of the received data, and the format data and the data are stored in the storage unit.

According to the second embodiment, the data is received, the format data which is the data generated in the format ready for the data processing is generated on the basis of the received data, and the format data and the data are stored in the storage unit.

Thus, the first and second embodiments of the present invention allow for storing the received data.

Further, according to the first and second embodiments of the present invention, it becomes possible to increase the speed of processing performed by the data-processing device by using the data received by the reception device.

### BRIEF DESCRIPTION OF THE DRAWINGS

FIG. 1 is a block diagram showing an example known personal computer;

FIG. 2 shows an example known descriptor;

FIG. 3 is a flowchart illustrating known DMA-transfer processing;

FIG. 4 is a flowchart illustrating an example of interruption processing performed by a known interruption handler;

FIG. 5 shows another example known descriptor;

FIG. 6 is a flowchart showing another example of the interruption processing performed by the known interruption handler;

FIG. 7 is a diagram illustrating the packet types;

FIG. 8 is a flowchart showing still another example of the interruption processing performed by the known interruption handler;

FIG. 9 is a flowchart illustrating setting processing;

FIG. 10 shows still another example known descriptor;

FIG. 11 is a diagram illustrating a known address class;

FIG. 12 is a flowchart illustrating setting processing other than the setting processing shown in FIG. 9;

FIG. 13 is a block diagram illustrating an example hardware configuration of a personal computer according to an embodiment of the present invention;

FIG. 14 is a block diagram illustrating the functions of the personal computer shown in FIG. 13;

FIG. 15 is a block diagram illustrating an example specific configuration of a DMA-control unit;

FIG. 16 shows the configuration of an IPv4 header;

FIG. 17 shows an example descriptor;

FIG. 18 is a flowchart illustrating DMA-transfer processing;

FIG. 19 is a flowchart illustrating generation processing;

FIG. 20 is a flowchart illustrating interruption processing;

FIG. 21 is a block diagram illustrating an example specific configuration of another DMA-control unit;

FIG. 22 shows another example descriptor;

FIG. 23 is a diagram illustrating an address class;

FIG. 24 is a flowchart illustrating generation processing other than the generation processing shown in FIG. 19;

FIG. 25 is a flowchart illustrating analysis processing; and

FIG. 26 is a flowchart illustrating interruption processing other than the interruption processing shown in FIG. 20.

### DESCRIPTION OF THE PREFERRED EMBODIMENTS

Hereinafter, embodiments of the present invention will be described in detail with reference to the attached drawings.

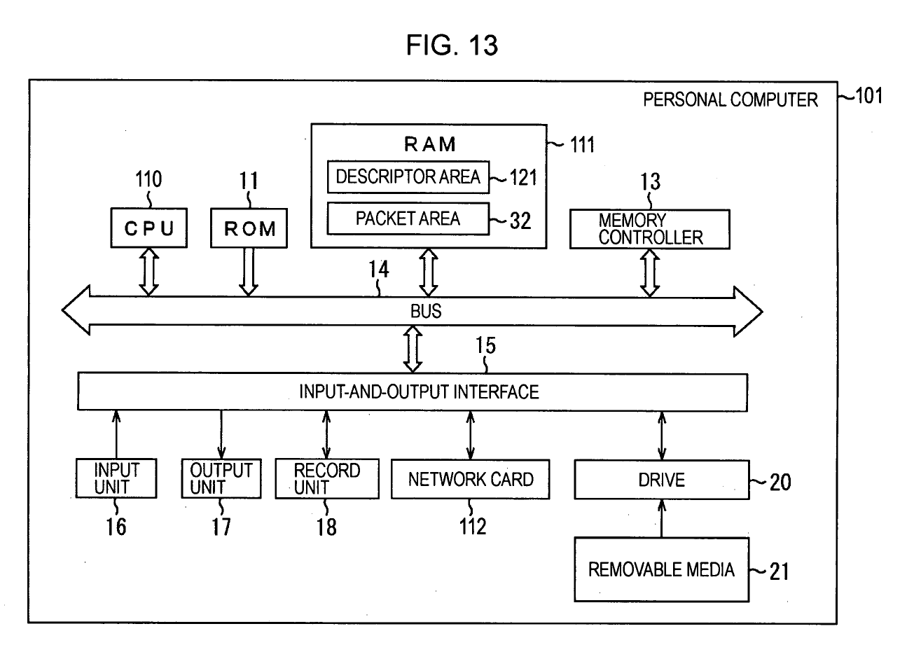

FIG. 13 is a block diagram showing an example hardware configuration of a personal computer (PC) 101 according to an embodiment of the present invention.

The PC 101 shown in FIG. 13 includes a read-only memory (ROM) 11, a memory controller 13, a bus 14, an input-and-output interface 15, an input unit 16, an output unit 17, a record unit 18, a drive 20, a central-processing unit (CPU) 110, a random-access memory (RAM) 111, and a network card 112.

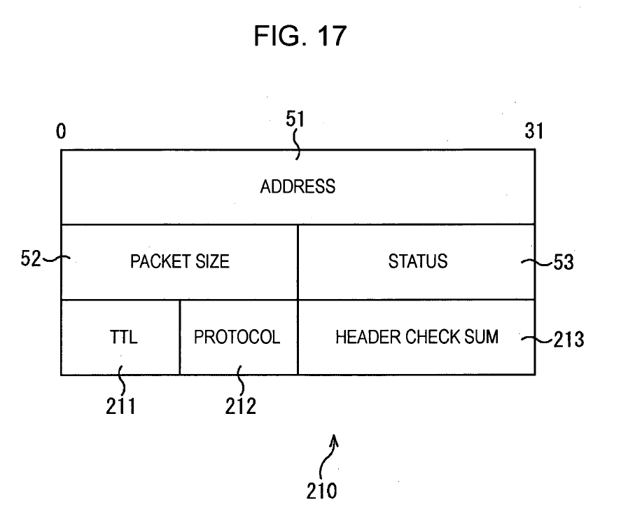

The following method is used in the above-described embodiment. Namely, in the PC 101, when data (i.e. a packet) received by the network card 112 is DMA-transferred to the RAM 111, the format of data including a header check sum (hereinafter referred to as header-check-sum data) is made to agree with the unit of processing performed by the CPU 110 (i.e. a processing word). Then, the header-check-sum data is stored in a descriptor 210 shown in FIG. 17 that will be described later.

The above-described header-check-sum data is generated by using predetermined data included in the received packet and used, so as to perform various interruption processing procedures including error checking or the like, for example. If the format of the header-check-sum data is different from the processing unit of the CPU 110, the load of processing performed by the CPU 110 increases, for example, when a comparison between a plurality of the header-check sums is made. For example, it is assumed that the processing unit of the CPU 110 is 32 bits, and 16-bit header-check-sum data calculated on the basis of the received packet is stored in the descriptor 210. In that case, the 16-bit header-check-sum data stored in the descriptor 210 is compared to 16-bit header-check-sum data included in the header of the received packet so that the header-check sums are compared to each other. Subsequently, the unit of the comparison processing is different from that of processing performed by the CPU 110, which increases the processing load placed on the CPU 110. The increased processing load becomes a contributing factor to an interruption of high-speed data processing. In the above-described embodiment, therefore, the format (the data size in this embodiment) of the header-check-sum data stored in the descriptor 210 is made to agree with the processing unit of the CPU 110, so as to decrease the processing load placed on the CPU 110.

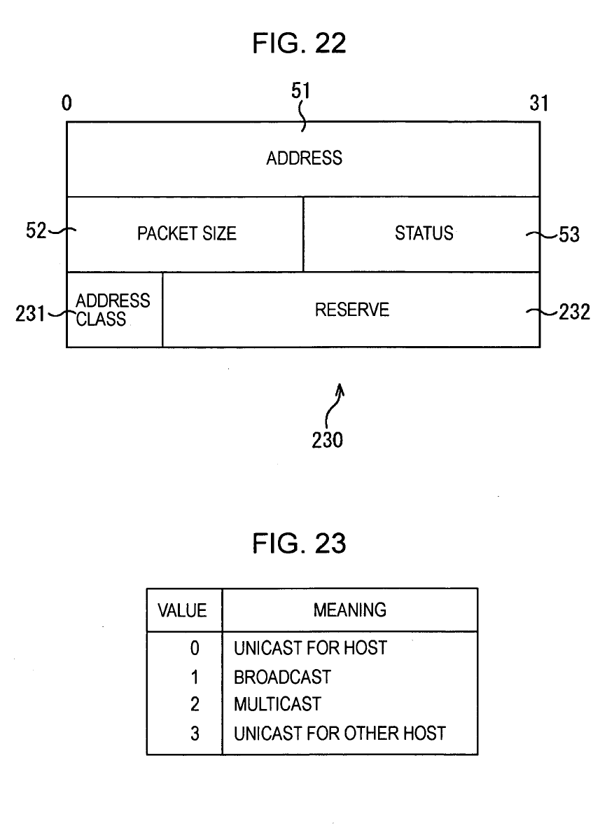

Further, when the DMA transfer is performed in the PC 101 of the above-described embodiment, a format which is set (used), as the packet type used during interruption processing is used, as the format of data on an address class indicating the result of an analysis of a MAC address of the received packet, which should be stored in a descriptor 230 shown in FIG. 22 which will be described later. More specifically, the format which is set (used), as the packet type, is defined, as parameters that are determined by a predetermined rule. Further, “format data”according to an embodiment of the present invention corresponds to the above-described address class and the header check sum, for example.

The address class is generated by analyzing the MAC address of the received packet and used, so as to perform various interruption processing procedures such as the packet-type setting. Here, when the data format of the address class is different from the format used during the packet-type setting, it is difficult for the CPU 110 to set the value of the address class, as it is, as the packet type. In that case, therefore, the CPU 110 determines the type of a packet on the basis of the address class and performs the packet-type setting according to the determined packet type. As a result, the processing load necessary for performing the packet-type setting or the like, the processing load being placed on the CPU 110, increases, and the increased processing load becomes another contributing factor to interruptions of the high-speed data processing. According to the above-described embodiment, therefore, the data format of the address class is set, as the packet type, during the interruption processing, so as to decrease the processing load placed on the CPU 110.

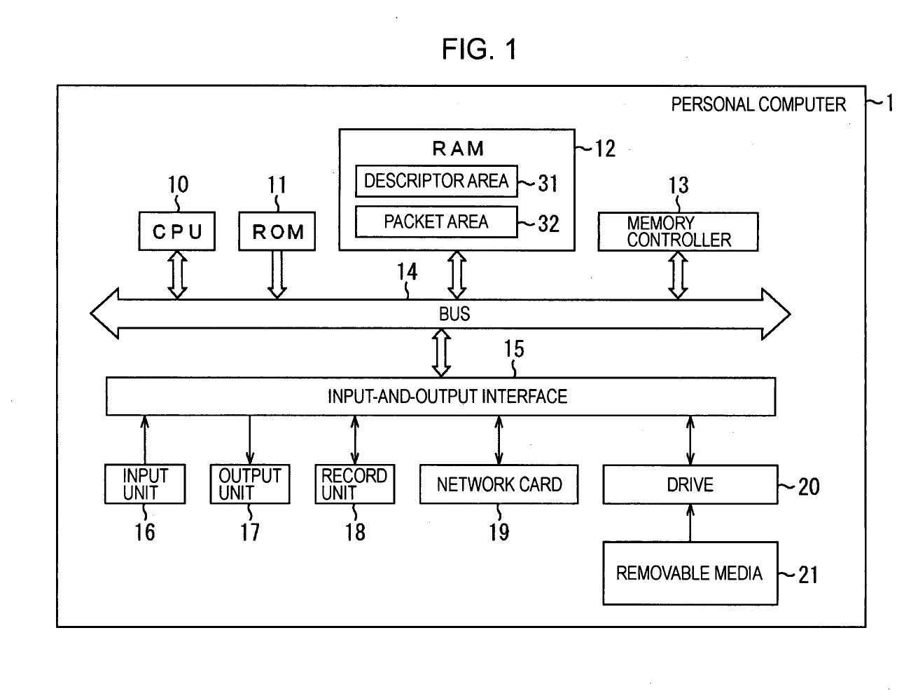

Hereinafter, the specific configuration of the PC 101 of the above-described embodiment will be described with reference to FIG. 13. In FIG. 13, however, the same elements as those shown in FIG. 1 will not be described. The same elements as those shown in FIG. 1 are designated by the same reference numerals and/or characters as those shown in FIG. 1.

The CPU 110 performs various processing procedures according to programs including a device driver or the like stored in the ROM 11 and/or the record unit 18. Here, the unit (word) of processing performed by the CPU 110 is determined to be 32 bits. Further, the CPU 110 can be used, as an example data-processing device according to an embodiment of the present invention.

For example, the CPU 110 records data on an address of the packet area 32 onto the descriptor area 121 of the RAM 111, as a descriptor 210 shown in FIG. 17 which will be described later. On the packet area 32, a packet which is DMA-transferred from the network card 112 via the memory controller 13 should be recorded. Further, the CPU 110 processes the packet which is DMA-transferred from the network card 112 to the packet area 32 of the RAM 111 on the basis of the descriptor 210 according to the program stored in the ROM 11 and/or the record unit 18.

Further, the CPU 110 starts an interruption handler of the device driver, thereby performing interruption processing by using the packet and the descriptor 210 corresponding to the packet.

The RAM 111 includes the descriptor area 121 on which the descriptor 210 is recorded, the packet area 32 on which the packet that is DMA-transferred from the network card 112 is recorded, and so forth. Here, the RAM 111 can be used, as an example storage unit according to an embodiment of the present invention.

The network card 112 receives a packet transmitted from a different device via a network (not shown), the packet being compliant with “Ethernet (Registered Trademark)”, and DMA-transfers the packet to the RAM 111 via the memory controller 13. Further, the network card 112 generates reception information relating to the received packet in a format ready for the interruption processing performed by the CPU 110. Then, the network card 112 transmits the reception information generated in the format ready for the. interruption processing (hereinafter referred to as interruption-ready-reception information) to the memory controller 13. Here, a MAC address is given to the network card 112. The network card 112 can be used, as an example reception device according to an embodiment of the present invention.

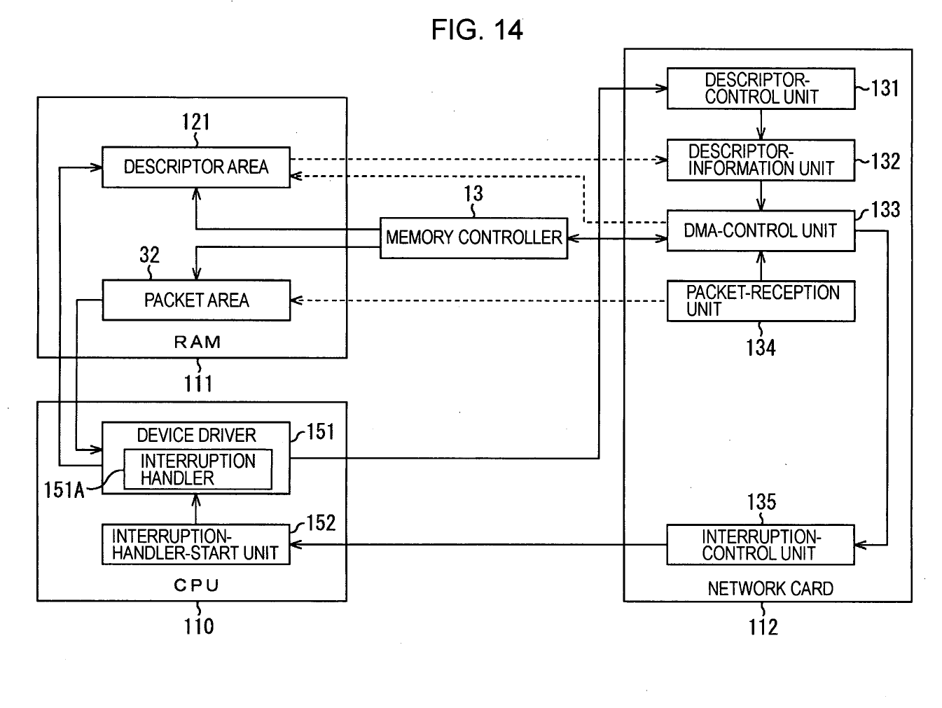

Next, FIG. 14 is a block diagram showing the functions of the PC 101 shown in FIG. 13.

The PC 101 shown in FIG. 14 includes the memory controller 13, the CPU 110, the RAM 111, and the network card 112.

The CPU 110 shown in FIG. 14 includes a device driver 151 and an interruption-handler-start unit 152.

The device driver 151 includes an interruption handler 151A. The device driver 151 sets (records) the descriptor 210 to the descriptor area 121 of the RAM 111, and informs a descriptor-control unit 131 that setting of the descriptor 210 is finished.

Further, the device deriver 151 starts the interruption handler 151A according to an instruction transmitted from the interruption-handler-start unit 152. The interruption handler 151A reads the packet from the packet area 32, reads the descriptor 210 corresponding to the read packet from the descriptor area 121, and performs interruption processing by using the packet and the descriptor 210. Here, the interruption handler 151A can be used, as an example processing unit according to an embodiment of the present invention.

The interruption-handler-start unit 152 receives an interruption notice transmitted from an interruption-control unit 135 (which will be described later) of the network card 112 and instructs the device driver 151 to start the interruption handler 151A according to the interruption notice.

The network card 112 includes the descriptor-control unit 131, a descriptor-information unit 132, a DMA-control unit 133, a packet-reception unit 134, and the interruption-control unit 135.

The descriptor-control unit 131 receives a notice transmitted from the device driver 151 of the CPU 110, the notice indicating that the descriptor setting is finished. Then, the descriptor-control unit 131 requests the descriptor-information unit 132 to DMA-transfer the descriptor 210 according to the received notice.

The descriptor-information unit 132 requests the DMA-control unit 133 to DMA-transfer the descriptor 210 according to the request for the DMA transfer of the descriptor 210, the request being transmitted from the descriptor-control unit 131. The descriptor-information unit 132 stores the descriptor 210 which is DMA-transferred from the descriptor area 121 of the RAM 111 via the memory controller 13 in an internal memory (not shown). Further, the descriptor-information unit 132 reads the descriptor 210 stored in the internal memory and transmits the descriptor 210 to the DMA-control unit 133.

The DMA-control unit 133 requests the memory controller 13 to DMA-transfer the descriptor 210 according to the request for the DMA-transfer of the descriptor 210, the request being transmitted from the descriptor-information unit 132. Further, on the basis of the packet transmitted from the packet-reception unit 134 and the descriptor 210 transmitted from the descriptor-information unit 132, the DMA-control unit 133 DMA-transfers the packet to the memory controller 3.

Further, the DMA-control unit 133 generates the interruption-ready-reception information on the basis of error information and the packet that are transmitted from the packet-reception unit 134 and DMA-transfers the interruption-ready-reception information to the memory controller 13. The DMA-control unit 133 transmits a notice to the interruption-control unit 135, the notice indicating that the DMA transfer of the packet is finished according to the notice transmitted from the memory controller 13, where the notice transmitted from the memory controller 13 indicates that the DMA transfer of the packet is finished.

The packet-reception unit 134 receives a packet transmitted from a different device via a network and stores the packet in an internal memory (not shown). Further, the packet-reception unit 134 transmits the stored packet to the DMA-control unit 133. Still further, the packet-reception unit 134 detects information about details on an error that occurs during the packet reception, generates the error information on the basis of the detection result, and transmits the error information to the DMA-control unit 133.

The interruption-control unit 135 transmits a notice to the interruption-handler-start unit 152, the notice indicating that an interruption occurs, in response to the notice transmitted from the DMA-control unit 133.

The memory controller 13 reads the descriptor 210 from the descriptor area 121 on the basis of the request for the DMA transfer of the descriptor 210, the request being transmitted from the DMA-control unit 133 of the network card 112, and transmits the descriptor 210 to the descriptor-information unit 132 so that the DMA transfer of the descriptor 210 is performed.

Further, the memory controller 13 records the packet which is DMA-transferred from the DMA-control unit 133 on the packet area 32. Further, the memory controller 13 stores the interruption-ready-reception information which is DMA-transferred from the DMA-control unit 133 in the descriptor 210 of the descriptor area 121 so that the descriptor 210 is updated. Further, the memory controller 13 transmits a notice to the DMA-control unit 133, the notice indicating that the DMA transfer of the packet is finished.

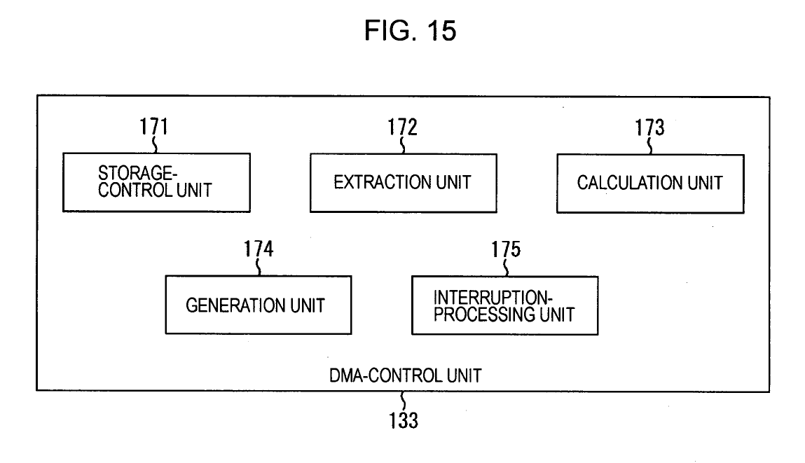

Next, FIGS. 15, 16, 17, 18, 19, and 20 show how the interruption handler 151A calculates the header check sum on the basis of the packet during the interruption processing.

FIG. 15 is a block diagram showing an example specific configuration of the DMA-control unit 133 shown in FIG. 14.

The DMA-control unit 133 shown in FIG. 15 includes a storage-control unit 171, an extraction unit 172, a calculation unit 173, a generation unit.174, and an interruption-processing unit 175. In the DMA-control unit 133 shown in FIG. 15, the generation unit 174 determines that a word of the CPU 110, that is, the size of 32-bit data, which is the unit of the interruption processing, to be a format ready for the interruption processing. Then, the generation unit 174 stores data including the header check sum provided in the determined format in the descriptor 210, as the interruption-ready-reception information. By performing the above-described processing procedures, the processing load placed on the CPU 110 can be decreased.

Next, on the basis of the packet transmitted from the packet-reception unit 134 shown in FIG. 14 and the descriptor 210 transmitted from the descriptor-information unit 132, the storage-control unit 171 transmits the packet to the memory controller 13 so that the packet is DMA-transferred.

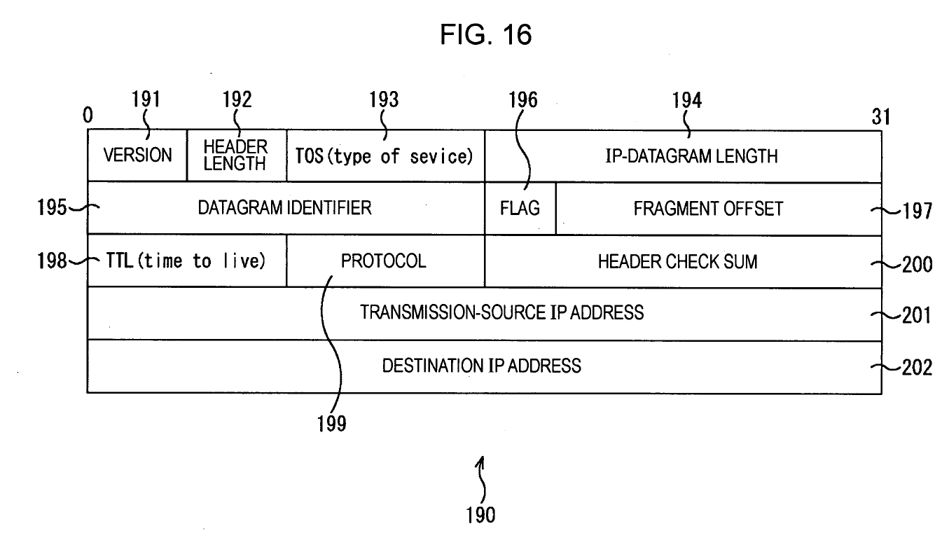

The extraction unit 172 extracts an Internet Protocol Version 4 (IPv4) header 190 (shown in FIG. 16 which will be described later) included in the packet transmitted from the packet-reception unit 134, and transmits the IPv4 header 190 to each of the calculation unit 173 and the generation unit 174. The calculation unit 173 calculates the header check sum on the basis of the IPv4 header 190 transmitted from the extraction unit 172 and transmits the header-check sum to the generation unit 174.

The packet-reception unit 134 transmits the error information to the generation unit 174. The generation unit 174 generates header-check-sum data of 32 bits which is the word of the CPU 110, as the interruption-ready-reception information, where the header-check-sum data includes the error information, an IP-datagram length 194 of the IPv4 header 190, a time-to-live (TTL) 198, a protocol 199, and the header check sum transmitted from the calculation unit 173.

The generation unit 174 transmits the interruption-ready-reception information to the memory controller 13 so that the interruption-ready-reception information is DMA-transferred. Then, the generation unit 174 stores the interruption-ready-reception information in the descriptor 210. The interruption-processing unit 175 transmits a notice to the interruption-control unit 135, the notice indicating that the DMA transfer of the packet is finished, in response to the notice transmitted from the memory controller 13, the notice indicating that the DMA transfer of the packet is finished.

FIG. 16 shows an example configuration of the IPv4 header 190.

The IPv4 header 190 shown in FIG. 16 includes a 4-bit version 191, a 4-bit header length 192, an 8-bit Type of Service (ToS) 193, and a 16-bit IP datagram length 194. The version 191 is provided, as information about the version of a packet, and the header length 192 is provided, as information about the length of the IPv4 header 190 including data from the version 191 to a destination IP address 202. The ToS 193 is provided, as information that determines the definition of data priority and that determines what type of transfer should be performed. The IP-datagram length 194 is provided, as information showing the entire length (data size) of the packet.

The IPv4 header 190 further includes (1) a 16-bit datagram identifier 195, (2) a 3-bit flag 196, and (3) a 13-bit fragment offset 197. The datagram identifier 195 is information used, so as to identify a packet, and the flag 196 is information used, so as to determine whether or not fragmenting is forbidden and/or determine whether or not the last part of a divided datagram is shown. The fragment offset 197 is information indicating the order in which the parts of the divided datagram are reassembled.

The IPv4 header 190 further includes (4) 8-bit TTL 198, (5) an 8-bit protocol 199, and (6) a 16-bit header-check sum 200. The TTL 198 is information indicating the time period during the packet can live, that is, the number of routers through which the packet can be transmitted. The protocol 199 is information indicating a high-order protocol. The header check sum 200 is information used, so as to judge an error which occurs in the IPv4 header.

Further, the IPv4 header 190 further includes (7) a 32-bit transmission-source IP address 201 and (8) a 32-bit transmission-destination IP address 202. The transmission-source IP address 201 is the IP address of a transmission-source device which transmitted the packet to the network card 112. The transmission-destination IP address is the IP address of a transmission-destination device to which the packet is transmitted.

Next, FIG. 17 shows an example of the descriptor 210 recorded onto the descriptor area 121 of the RAM 111.

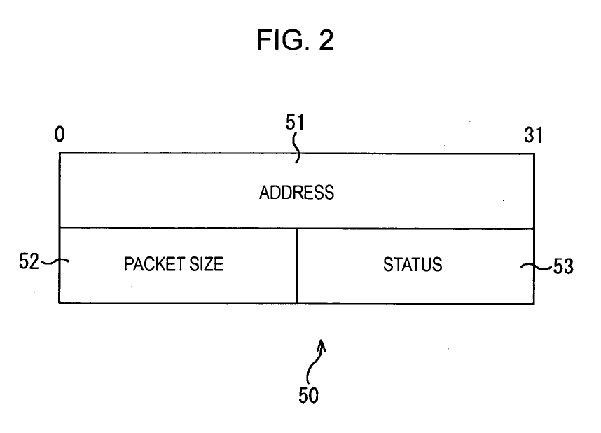

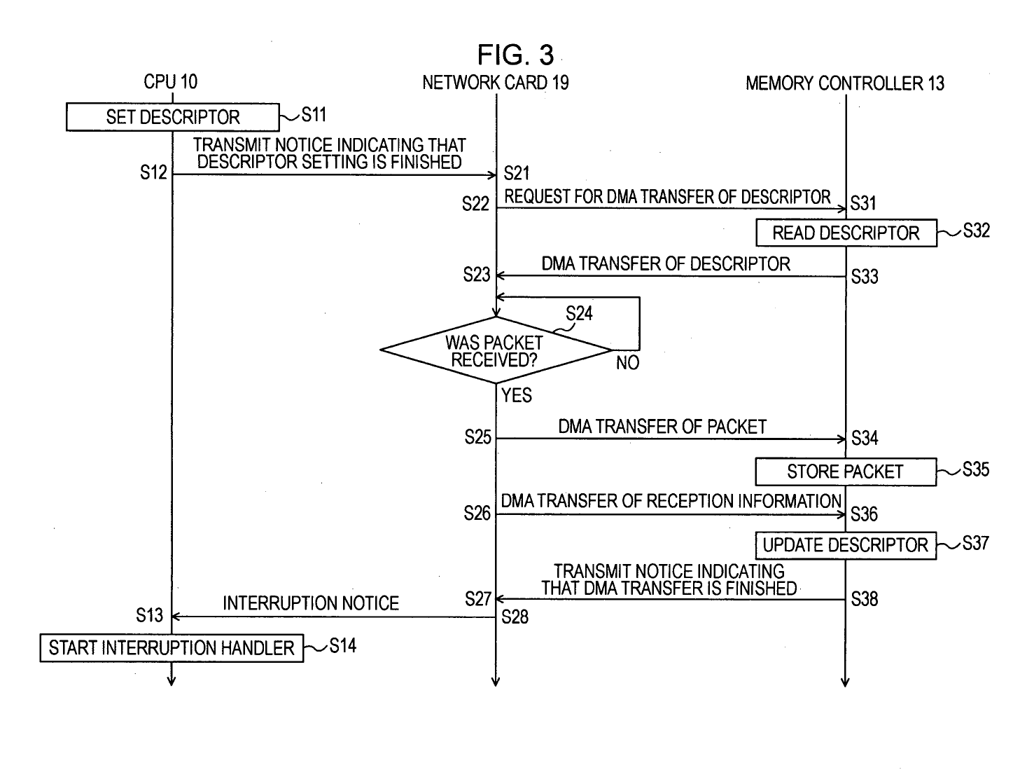

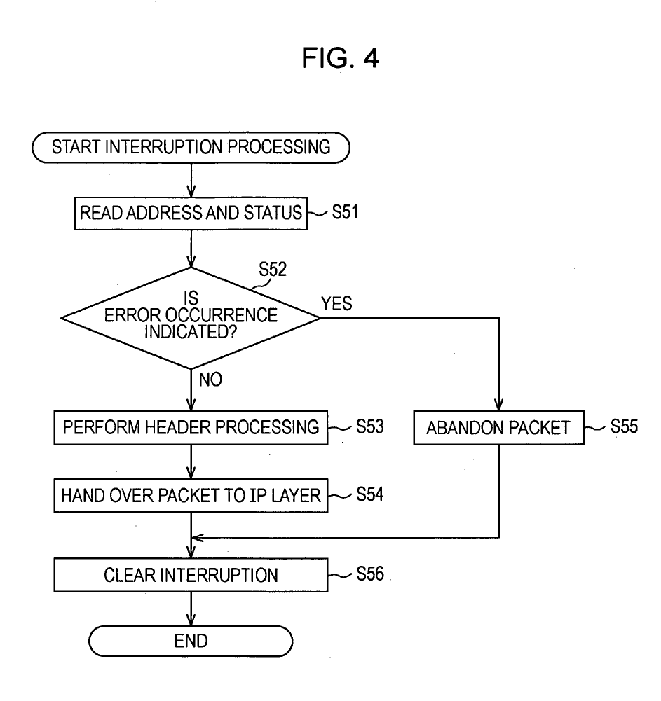

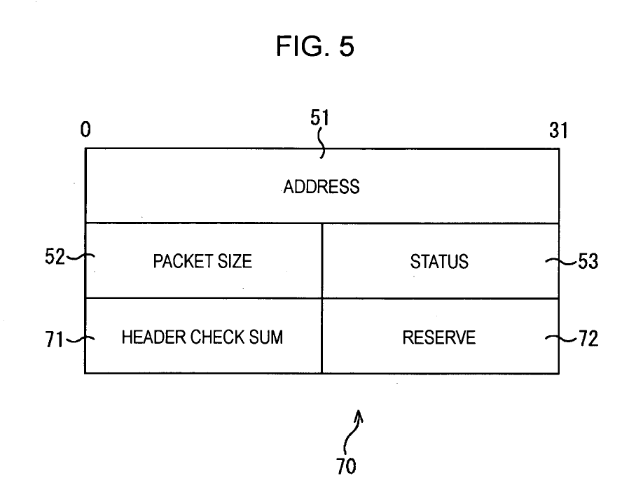

The descriptor 210 shown in FIG. 17 includes an address 51, a packet size 52, a status 53, a TTL 211, a protocol 212, and a header check sum 213. In FIG. 17, the same elements as those shown in FIG. 2 will not be described. The same elements as those shown in FIG. 2 are designated by the same reference numerals and/or characters as those shown in FIG. 2.

The TTL 211 is the same information as the 8-bit TTL 198 included in the IPv4 header 190 (shown in FIG. 16) of the transmitted packet. The protocol 212 is the same information as the 8-bit protocol 199 included in the Ipv4 header 190 of the transmitted packet. The header check sum 213 is a 16-bit header check sum calculated by the calculation unit 173.

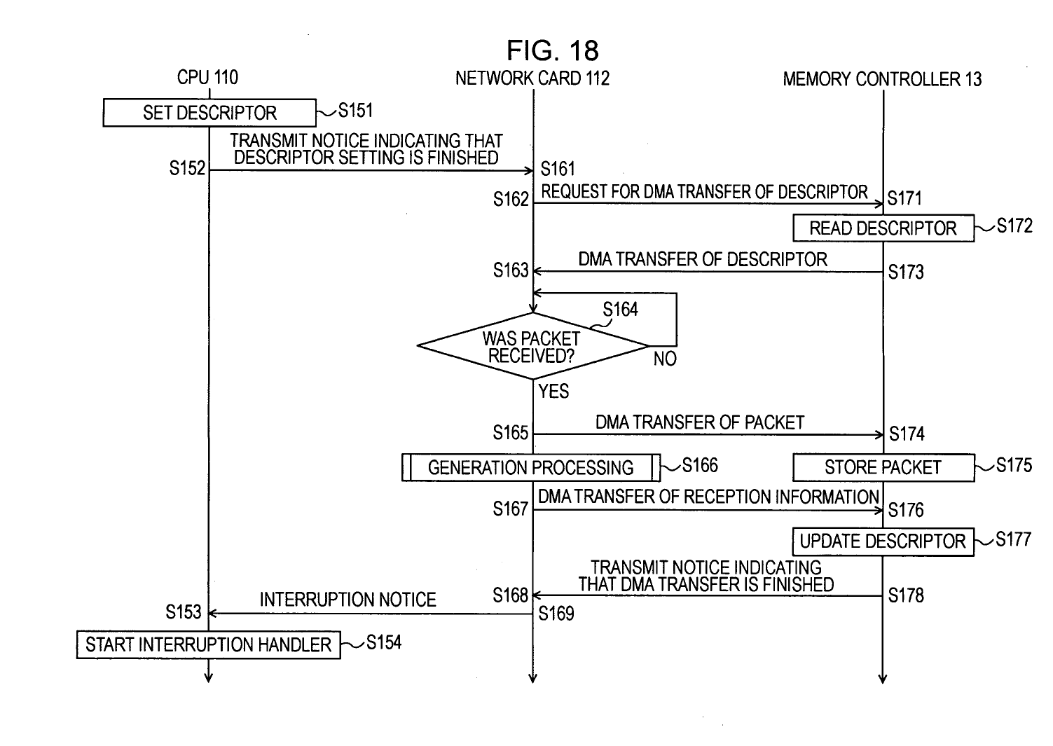

Next, the DMA-transfer processing performed by the PC 101 will be described with reference to FIG. 18.

At step S151, the device driver 151 of the CPU 110 sets (records) the descriptor 210 shown in FIG. 17 onto the descriptor area 121 of the RAM 111. At that time, information about the address of the packet area 32 prepared, so as to record the packet which is DMA-transferred from the network card 112 is stored in the descriptor 210, as the address 51, and information about the size of the packet area 32 is stored in the descriptor 210, as the packet size 52.

After step S151, the processing advances to step S152 so that the device driver 151 of the CPU 110 transmits a notice to the descriptor-control unit 131 of the network card 112, the notice indicating that the setting of the descriptor 210 is finished.

At step S161, the descriptor-control unit 131 of the network card 112 receives the notice transmitted from the CPU 110, the notice indicating that the setting of the descriptor 210 is finished, and requests the descriptor-information unit 132 to DMA-transfer the descriptor 210 in response to the above-described notice. The descriptor-information unit 132 transmits information about the address of the descriptor area 121 and the size of the descriptor 210, where the information had already been stored in an internal memory (not shown), and the request for the DMA transfer of the descriptor 210 to the DMA-control unit 133.

After step S161 is finished, the processing advances to step S162 so that the DMA-control unit 133 requests the memory controller 13 to DMA-transfer the descriptor 210 in response to the DMA-transfer request transmitted from the descriptor-information unit 132. At the same time, the DMA-control unit 133 transmits the address-and-size information transmitted from the descriptor-information unit 132 to the memory controller 13.

At step S171, the memory controller 13 receives the request for the DMA transfer of the descriptor 210, and the. information about the address of the descriptor area 121 and the size of the descriptor 210, the request and the information being transmitted from the DMA-control unit 133 of the network card 112. Then, the memory controller 13 advances to step S172.

At step S172, the memory controller 13 reads the descriptor 210 from the descriptor area 121 of. the RAM 111 on the basis of the address-and-size information transmitted from the DMA-control unit 133, and advances to step S173. At step S173, the memory controller 13 transmits the descriptor 210 read, at step S172, to the descriptor-information unit 132 of the network card 112 so that the DMA transfer of the descriptor 210 is performed.

At step S163, the descriptor-information unit 132 of the network card 112 receives the descriptor 210 which is DMA-transferred from the memory controller 13, and stores the descriptor 210 in the internal memory (not shown). Further, the descriptor-information unit 132 reads and transmits the stored descriptor 210 to the DMA-control unit 133.

After step S163, the processing advances to step S164 so that the packet-reception unit 134 of the network card 112 determines whether or not the packet is transmitted from a different device (not shown) via a network. If it is determined that the packet is not transmitted, the packet-reception unit 134 waits until the packet is transmitted.

If it is determined that the packet is transmitted, at step S164, the packet-reception unit 134 stores the packet in the internal memory (not shown), detects information about details on the error occurrence, and generates error information indicating the detection result. Then, the packet-reception unit 134 transmits the packet and the error information to the DMA-control unit 133.

Then, at step S165, the DMA-control unit 133 specifies the address 211 of the descriptor 210 transmitted from the descriptor-information unit 132, and transmits the packet transmitted from the packet-reception unit 134 to the memory. controller 13 so that the DMA transfer of the packet is performed and the packet is recorded onto the packet area 32 via the memory controller 13.

At step S174, the memory controller 13 specifies the address 211, receives the packet which is DMA-transferred from the DMA-control unit 133, and advances to step S175. At step S175, the memory controller 13 records the packet transmitted from the memory controller 13 onto the packet area 32 at the address 211.

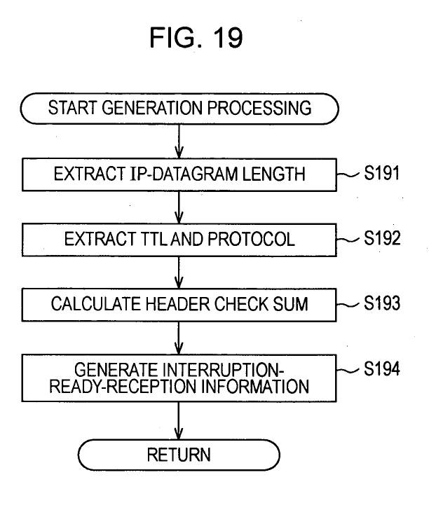

At step S166, the DMA-control unit 133 of the network card 112 performs generation processing, so as to generate interruption-ready-reception information of the packet transmitted from the packet-reception unit 134. The details on the generation processing will be described later with reference to FIG. 19.

After step S166, the processing advances to step S167 so that the DMA-control unit 133 transmits the interruption-ready-reception information generated, at step S166, to the memory controller 13. As a result, the DMA transfer of the interruption-ready-reception information is performed and the interruption-ready-reception information is stored (recorded) in the descriptor 210 of the descriptor area 121 via the memory controller 13.

At step S176, the memory controller 13 receives the interruption-ready-reception information transmitted from the DMA-control unit 133 of the network card 112 and advances to step S177. At step S177, the memory controller 13 stores the transmitted interruption-ready-reception information in the descriptor 210 so that the descriptor 210 is updated.

More specifically, the memory controller 13 stores (updates) the IP-datagram length 194 included in the interruption-ready-reception information, as the packet size 52, and stores the error information, as the status 53. Further, the memory controller 13 stores the TTL 198, protocol 199, and header check sum of the header-check-sum data, as the TTL 211, the protocol 212, and the header check sum 213.

After step S177, the processing advances to step S178 so that the memory controller 13 transmits a notice to the DMA-control unit 133 of the network card 112, the notice indicating that DMA-transfer of the packet is finished, and finishes the processing.

At step S168, the DMA-control unit 133 of the network card 112 receives the notice indicating that the DMA transfer of the packet is finished, the notice being transmitted from the memory controller 13, and transmits a notice to the interruption-control unit 135, the notice indicating that the DMA transfer is finished.

After step S168, the processing advances to step S169 so that the interruption-processing unit 135 transmits a notice about an interruption to the CPU 110 in response to the notice transmitted from the DMA-control unit 133, the notice indicating that the DMA transfer of the packet is finished, and finishes the processing.

At step S153, the interruption-handler-start unit 152 of the CPU 110 receives the interruption notice transmitted from the network card 112 and instructs the device driver 151 of the CPU 110 to start the interruption handler 151A in response to the interruption notice. After step S153, the processing advances to step S154 so that the device driver 151 starts the interruption handler 151A according to the instruction transmitted from the interruption-handler-start unit 152 and finishes the processing.

Next, generation processing performed at step S166 shown in FIG. 18 will be described with reference to FIG. 19.

At step S191, the extraction unit 172 extracts the IP-datagram length 194 from the IPv4 header 190 of the packet transmitted from the packet-reception unit 134 and transmits the IP-datagram length 194 to the generation unit 174.

After step S191, the processing advances to step S192 so that the extraction unit 172 extracts the TTL 198 and the protocol 199 from the IPv4 header 190 of the packet transmitted from the packet-reception unit 134, and transmits the TTL 198 and the protocol 199 to the generation unit 174.

After step S192, the processing advances to step S193 so that the calculation unit 173 calculates a header check sum on the basis of the IPv4 header 190 of the packet transmitted from the packet-reception unit 134 and transmits the calculated header check sum to the generation unit 174.

After step S193, the processing advances to step S194 so that the generation unit 174 generates 32-bit header-check-sum data, as the interruption-ready-reception information, where the 32-bit header-check-sum data includes the error information transmitted from the packet-reception unit 134, the IP-datagram length 194 transmitted from the extraction unit 172, the TTL 198, the protocol 199, and the header check sum calculated, at step S193. Then, the processing advances to step S167 shown in FIG. 18.

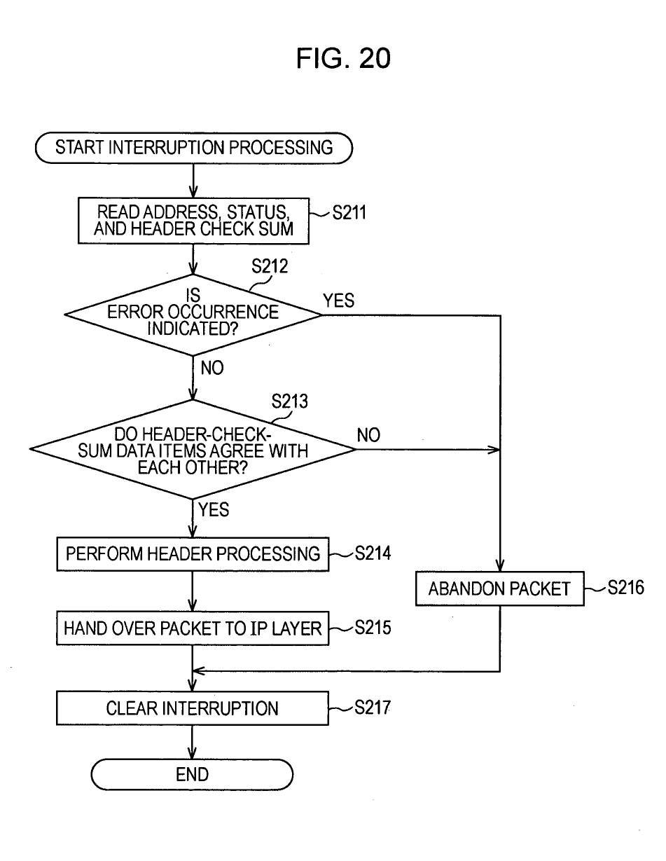

Next, interruption processing performed by the interruption handler 151A will be described with reference to FIG. 20. The interruption processing is started when the interruption handler 151A is started, at step S154 shown in FIG. 18, for example.

At step S211, the interruption handler 151A reads 32-bit header-check-sum data including the address 51, the status 53, the TTL 211, the protocol 212, and the header check sum 213 from the descriptor 210 (shown in FIG. 17) recorded onto the descriptor area 121 of the RAM 111, and advances to step S212.

At step S212, the interruption handler 151A determines whether or not the status 53 read, at step S211, indicates the error occurrence. If it is determined that the status 53 does not indicate the error occurrence, the processing advances to step S213.

At step S213, the interruption handler 151A reads the packet recorded onto the packet area 32 at the address 51 on the basis of the address 51 read, at step S211. Then, the interruption handler 151A determines whether or not the 32-bit header-check-sum data including the TTL 198 and the protocol 199 that are included in the IPv4 header 190 of the packet, and the header-check sum 200 agrees with the 32-bit header-check-sum data stored in the descriptor 210.

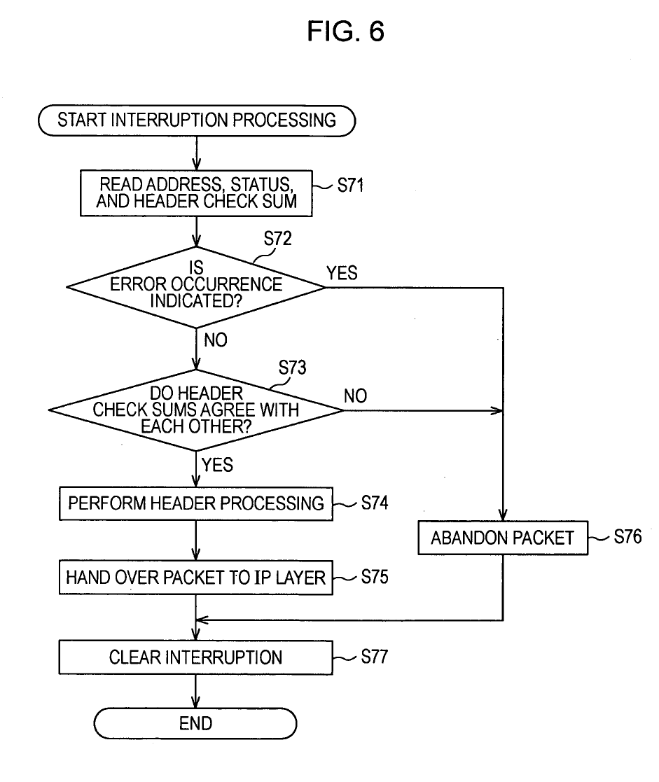

Thus, at step S213, the interruption handler 151A makes a comparison between the header-check-sum data items of 32 bits that correspond to the word of the CPU 110. Therefore, it becomes possible to perform the comparison with a higher speed than in the case where a comparison is made between header-check-sum data items of 16 bits that correspond to half the word of the CPU 110 (step S73 shown in FIG. 6). As a result, the speed of the interruption processing increases.

If it is determined that the header-check-sum data items agree with each other, at step S213, the processing advances to step S214 so that the interruption handler 151A performs header processing, so as to remove an Ethernet header or the like from the read packet. After step S214, the processing advances to step S215 so that the interruption handler 151A hands over the packet that had been subjected to the header processing to a high-order IP layer, and advances to step S217.

On the other hand, if it is determined that the status 53 indicates the error occurrence, at step S212, or if it is determined that the header-check-sum data items do not agree with each other, at step S213, the processing advances to step S216 so that the interruption handler 151A abandons (deletes) the packet recorded onto the packet area 32 at the address 51 and advances to step S217. At step S217, the interruption handler 151A clears the interruption notice transmitted, at step S153 shown in FIG. 18, and finishes the processing.

As described above, the network card 112 stores not only the 16-bit header-check-sum data in the descriptor 210 but also the header-check-sum data of the 32-bit size corresponding to the word of the CPU 110, where the 32-bit header-check-sum data includes the TTL 211, the protocol 212, and the header check sum 213. Therefore, the CPU 110 can make a comparison between header check sums with high speed by comparing the 32-bit header-check-sum data stored in the descriptor 210 with the 32-bit header-check-sum data included in the IPv4 header 190.

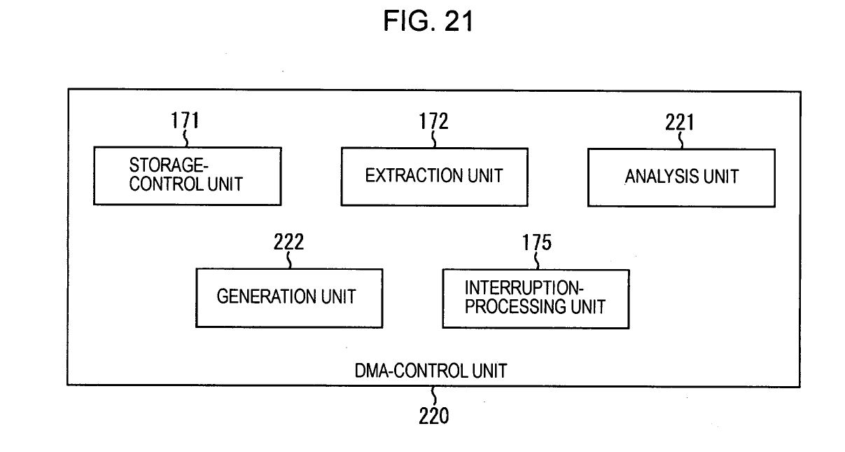

Next, FIGS. 21, 22, 23, 24, 25, and 26 show how the interruption handler 151A operates on Linux and sets the value indicating the result of an analysis of a MAC address written in the Ethernet header of a packet, as the packet type (skb->pkt_type) during the interruption processing (the function eth_type_trans).

In that case, the DMA-control unit shown in FIG. 14 is configured, as shown in FIG. 21.

A DMA-control unit 220 shown in FIG. 21 includes the storage-control unit 171, the extraction unit 172, the interruption-processing unit 175, an analysis unit 221, and a generation unit 222. According to another embodiment of the present invention, the generation unit 222 determines a format in which a value that is set (used), as the packet type, is used during the interruption processing to be a format ready for the interruption processing. Further, the generation unit 222 stores an address class indicating the result of the MAC-address analysis in the descriptor 230, as reception information. Here, the address class is generated and shown in the above-described format ready for the interruption processing.

The same elements shown in FIG. 21 as those shown in FIG. 15 will not be described. The same elements as those shown in FIG. 15 are designated by the same reference numerals and/or characters as those shown in FIG. 15.

The analysis unit 221 analyzes the MAC address included in the Ethernet header of the packet transmitted from the packet-reception unit 134 and transmits information about an address class indicating the analysis result to the generation unit 222.

The generation unit 222 generates interruption-ready-reception information including the error information transmitted from the packet-reception unit 134, the IP-datagram length 194 transmitted from the extraction unit 172, and the address class transmitted from the analysis unit 221. The generation unit 222 DMA-transfers the interruption-ready-reception information by transmitting the interruption-ready-reception information to the memory controller 13 so that the interruption-ready-reception information is stored in the descriptor 230.

Next, FIG. 22 shows an example descriptor recorded onto the descriptor area 121 when the DMA-control unit 133 shown in FIG. 14 is provided, as the DMA-control unit 220 shown in FIG. 21.

The descriptor 230 shown in FIG. 22 stores the address 51, the packet size 52, the status 53, an address class 231, and a reserve 232. The same elements shown in FIG. 22 as those shown in FIG. 2 will not be described. The same elements shown in FIG. 22 are designated by the same reference numerals and/or characters as those shown in FIG. 2.

The address class 231 is an address class indicating the result of an analysis performed by the analysis unit 221. The reserve 232 is provided, as a free area.

Next, the address class 231 will be described with reference to FIG. 23.

When the value of the address class 231 is zero, as shown in FIG. 23, the address class 231 shows the analysis result indicating that a transmitted packet is a packet transmitted to the own device through unicast. When the value of the address class 231 is one, the address class 231 shows the analysis result indicating that the transmitted packet is a packet transmitted through broadcast.

When the value of the address class 231 is two, the analysis result indicates that the transmitted packet is a packet transmitted through multicast. When the value of the address class 231 is three, the analysis result indicates that the transmitted packet is a packet transmitted to the different computer through unicast.

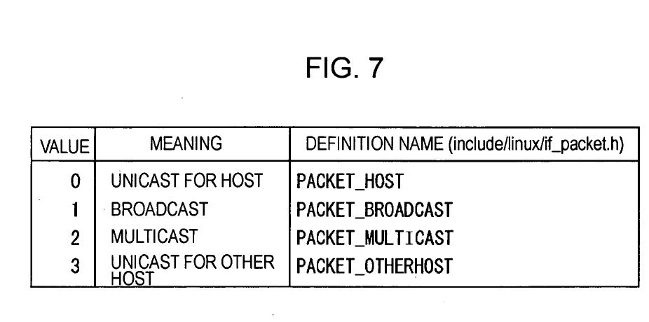

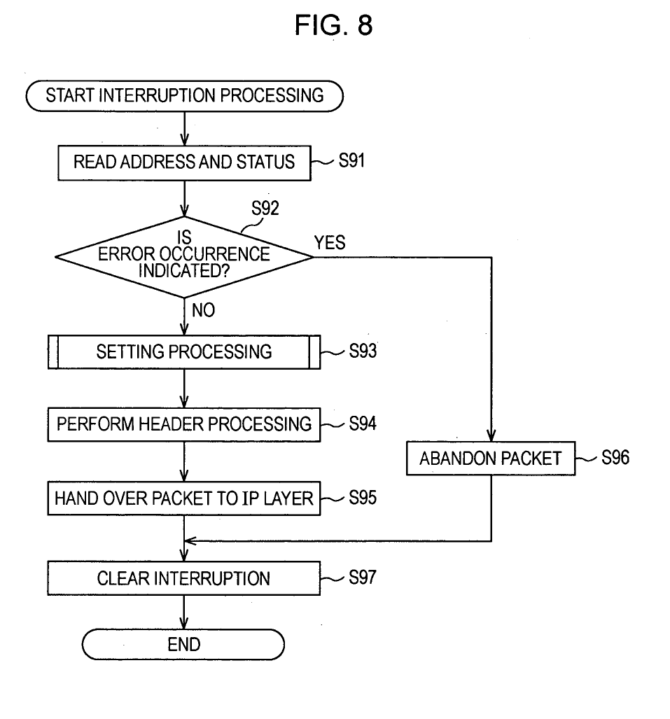

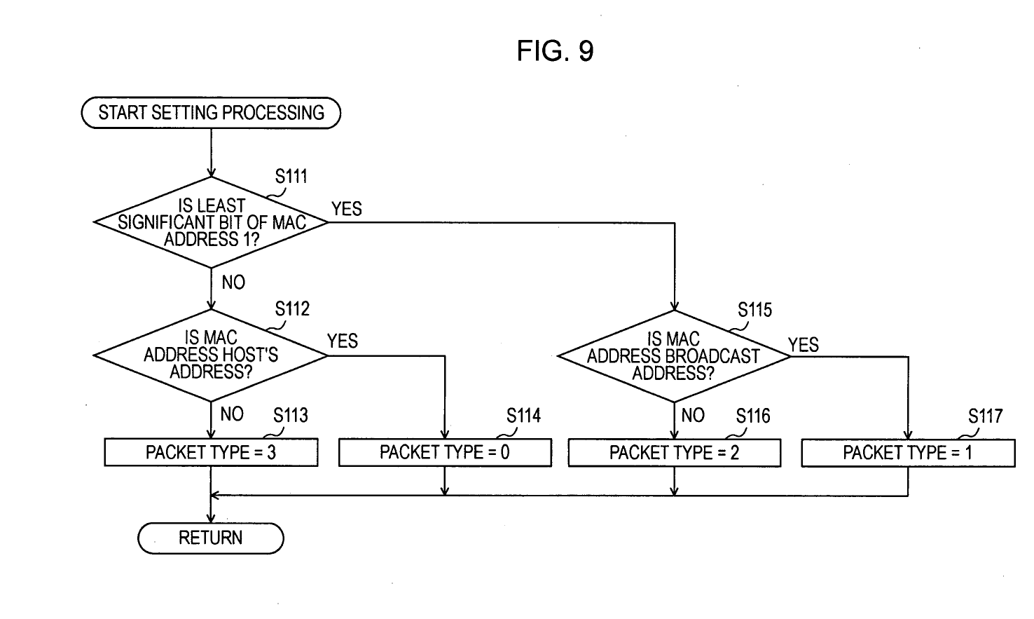

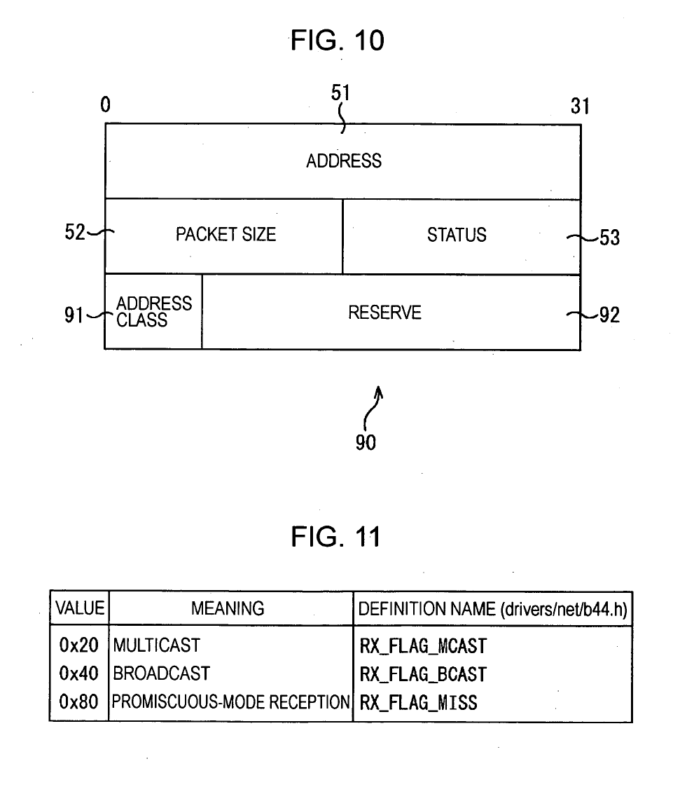

As described above, the value of the address class 231 showing the analysis results is the same as the value (shown in FIG. 7) of the packet type (skb->pkt_type) set by the interruption handler 151A operating on Linux.

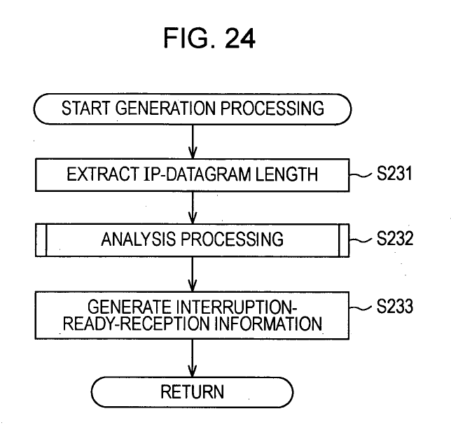

Next, generation processing performed by the DMA-control unit 220 shown in FIG. 21 will be described with reference to FIG. 24.

Since the processing corresponding to step S231 is the same as that corresponding to step S191 shown in FIG. 19, the description of step S231 will not be provided.

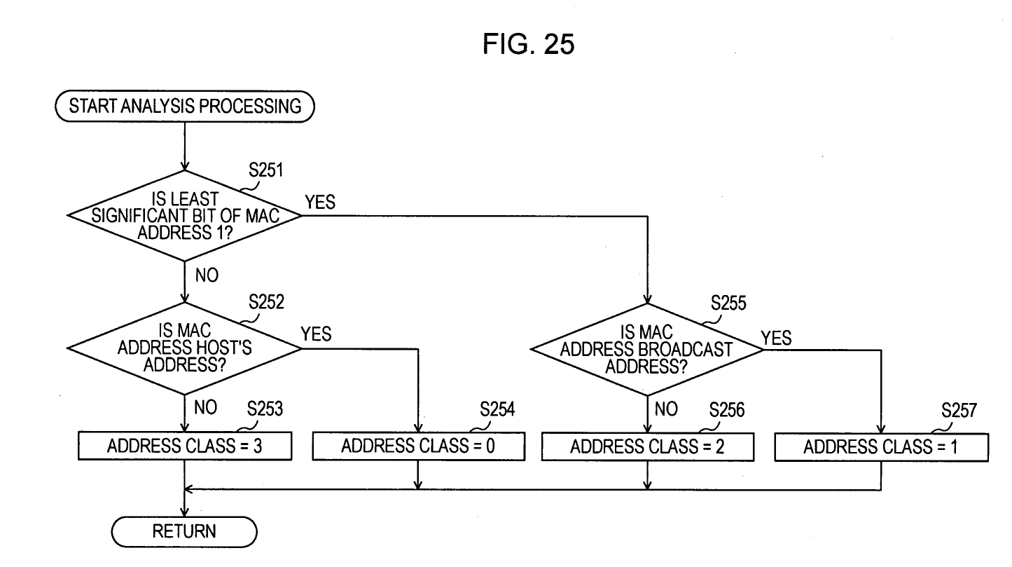

After step S231, the processing advances to step S232 so that the analysis unit 221 performs an analysis of the MAC address of the Ethernet header of the packet transmitted from the packet-reception unit 134. The details on the analysis processing will be described later with reference to FIG. 25.

After step S232, the processing advances to step S233 so that the generation unit 222 generates interruption-ready-reception information including the error information transmitted from the packet-reception unit 134, the IP-datagram length 194 transmitted from the extraction unit 172, and the address class transmitted from the analysis unit 221. Then, the processing advances to step S167 shown in FIG. 18.

Next, analysis processing performed, at step S232 shown in FIG. 24, will be described with reference to FIG. 25.

At step S251, the analysis unit 221 determines whether or not the value of the least significant bit of the MAC address written in the Ethernet header of the packet transmitted from the packet-reception unit 134 is one. Namely, the analysis unit 221 determines whether the transmitted packet is a packet transmitted through broadcast or a packet transmitted through multicast.

At step S251, if it is determined that the value of the least significant bit of the MAC address is not one, namely, if it is determined that the transmitted packet is a packet transmitted through unicast, the processing advances to step S252 so that the analysis unit 221 determines whether or not the MAC address is the own device's address (a MAC address given to the network card 112).

If it is determined that the MAC address is not the own device's address, at step S252, that is to say, if the transmitted packet is a packet transmitted to the different computer through unicast, the processing advances to step S253 so that the analysis unit 221 sets the packet-type value to three, and the processing advances to step S233 shown in FIG. 24.

On the other hand, if it is determined that the MAC address is the own device's address, at step S252, that is to say, if the transmitted packet is the packet transmitted to the own device through unicast, the processing advances to step S254 so that the analysis unit 221 sets the packet-type value to zero, and the processing advances to step S233 shown in FIG. 24.

Further, if it is determined that the least significant bit of the MAC address is one, the processing advances to step S255 so that the analysis unit 221 determines whether or not the MAC address is a broadcast address, namely, whether or not each of the entire bits of the MAC address is one.

If it is determined that the MAC address is not the broadcast address, at step S255, the processing advances to step S256 so that the analysis unit 221 sets the packet-type value to two, and the processing advances to step S233 shown in FIG. 24.

On the other hand, if it is determined that the MAC address is the broadcast address, at step S255, the processing advances to step S257 so that the analysis unit 221 sets the packet-type value to one, and the processing advances to step S233 shown in FIG. 24.

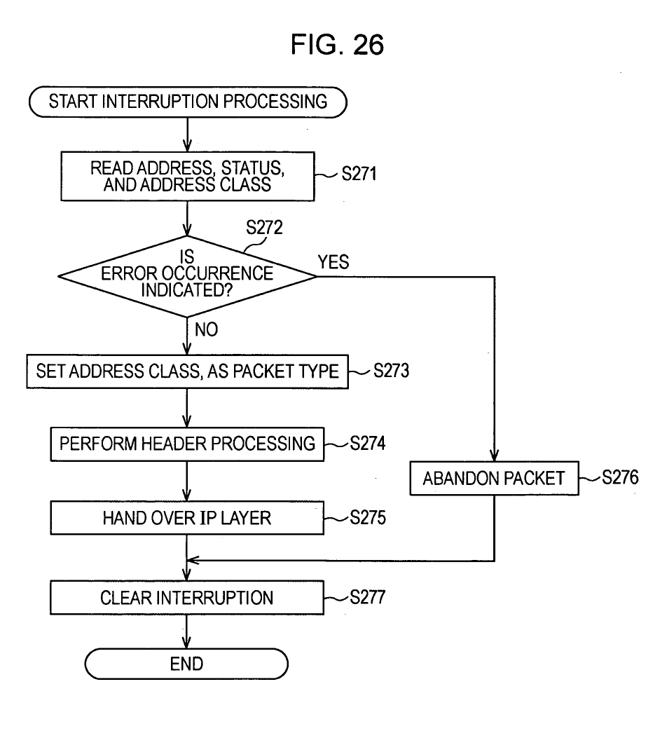

Next, interruption processing performed by the interruption handler 151A operating on Linux will be described with reference to FIG. 26. The interruption processing is started, for example, when the interruption handler is started, at step S154 shown in FIG. 18.

At step S271, the interruption handler 151A reads the address 51, the status 53, and the address class 231 from the descriptor 230 (shown in FIG. 22) recorded onto the descriptor area 121 of the RAM 111, and advances to step S272.

At step S272, the interruption handler 151A determines whether or not the status 53 read, at step S271, indicates the error occurrence. If it is determined that the status 53 does not indicate the error occurrence, the processing advances to step S273.

At step S273, the interruption handler 151A determines the address class 231 read, at step S271, as the packet type.

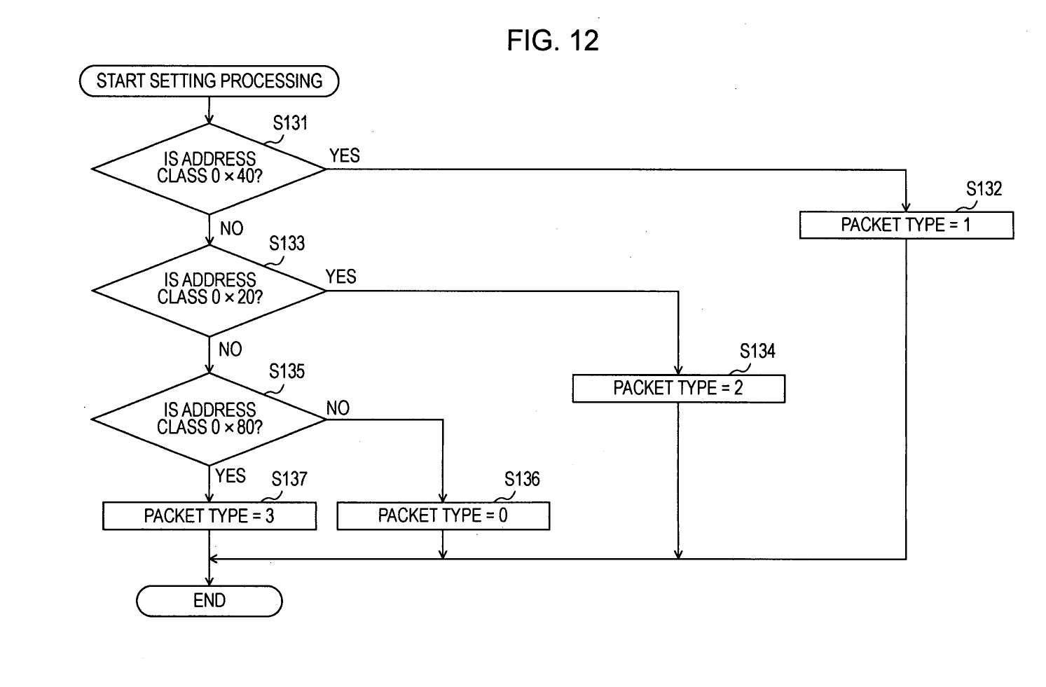

Since the value of the address class 231 indicating each of the analysis results is the same as that of the packet type indicating each of the analysis results, as described above, the interruption handler 151A can set the address class 231 stored in the descriptor 230, as the packet type, as it is. Subsequently, it becomes possible to perform the interruption processing with a speed higher than in the case where known interruption processing is performed, so as to perform the setting processing shown in FIG. 12.

Since the processing corresponding to steps S274, S275, S276, and S277 is the same as that corresponding to steps S214, S215, S216, and S217 that are shown in FIG. 20, the description of the processing corresponding to steps S274 to S277 will not be provided.

Thus, the network card 112 uses the packet-type value used during the interruption processing performed by the CPU 110, as the value of the address class 231, and stores the packet-type value into the descriptor 230. Therefore, the CPU 110 can set the address class 231 stored in the descriptor 210, as the packet type, as it is. As a result, the CPU 110 can perform processing of setting the packet type with high speed.

According to the above-described embodiment, the value of the address class 231 indicating each of the analysis results is the same as the value (shown in FIG. 7) of the packet type (skb->pkt_type) that is set during the interruption processing performed by the interruption handler 151A operating on Linux. However, the value of the address class 231 may be the same as that of the result of an analysis of the MAC address which is set during interruption processing performed by an interruption handler operating on an operating system (OS) other than Linux.

Further, the value of the address class 231 showing each of the analysis results may be set in advance at the manufacturing time. Further, the value of the address class 231 may be set, so as to be adaptable to a predetermined OS by initializing the network card 112.

Thus, the network card 112 generates the reception information in the format ready for the interruption processing performed by the CPU 110 and stores the generated reception information, that is, interruption-ready-reception information in the descriptor 210 and/or the descriptor 230 of the descriptor area 121. Subsequently, the CPU 110 can perform processing with an increased speed.

Further, in this specification, steps describing a program stored in a program-recording medium include not only processing executed in time sequence according to the written order but also processing that is not necessarily executed in time sequence but can be executed in parallel and/or separately.

It should be understood by those skilled in the art that various modifications, combinations, sub-combinations and alterations may occur depending on design requirements and other factors insofar as they are within the scope of the appended claims or the equivalents thereof.

What is claimed is:

1. An information-processing system including a reception device configured to receive data and a data-processing device configured to perform data processing by using the data,
wherein the reception device includes:
reception means configured to receive the data; and
storage-control means configured to generate format data which is data generated in a format ready for the data processing on the basis of the received data and store the format data and the data in storage means, and
wherein the data-processing device includes processing means configured to perform the data processing by using the data and the format data that are stored in the storage means.

2. A reception device making storage means store data used by a data-processing device, so as to perform data processing, the reception device comprising:
reception means configured to receive the data; and
storage-control means configured to generate format data which is data generated in a format ready for the data processing on the basis of the received data and store the format data and the data in the storage means.

3. The reception device according to claim 1, wherein the format ready for the data processing is a size of a processing unit used when the data processing is performed.

4. The reception device according to claim 1, wherein the format ready for the data processing is a format in which a value used for the data processing is used.

5. A program making a computer perform processing so that storage means stores data used by a data-processing device, so as to perform data processing, the program comprising the steps of:
receiving the data; and
generating format data which is data generated in a format ready for the data processing on the basis of the received data and storing the format data and the data in the storage means.

6. An information-processing system including a reception device configured to receive data and a data-processing device configured to perform data processing by using the data,
wherein the reception device includes:
a reception unit configured to receive the data; and
a storage-control unit configured to generate format data which is data generated in a format ready for the data processing on the basis of the received data and store the format data and the data in a storage unit, and
wherein the data-processing device includes a processing unit configured to perform the data processing by using the data and the format data that are stored in the storage unit.

7. A reception device making a storage unit store data used by a data-processing device, so as to perform data processing, the reception device comprising:
a reception unit configured to receive the data; and
a storage-control unit configured to generate format data which is data generated in a format ready for the data processing on the basis of the received data and store the format data and the data in the storage unit.
